(19) United States
(12) Patent Application Publication
(10) Pub. No.: US 2023/0081631 A1
(43) Pub. Date: Mar. 16, 2023

(54) VISUAL RECOGNITION SYSTEM AND VISUAL RECOGNITION METHOD

(71) Applicant: MITSUBISHI HEAVY INDUSTRIES, LTD., Tokyo (JP)

(72) Inventors: Masaki HONDA, Tokyo (JP); Gen SAKASHITA, Tokyo (JP); Tomohiro HIGUCHI, Tokyo (JP)

(73) Assignee: MITSUBISHI HEAVY INDUSTRIES, LTD., Tokyo (JP)

(21) Appl. No.: 17/940,363

(22) Filed: Sep. 8, 2022

(30) Foreign Application Priority Data
Sep. 10, 2021 (JP) 2021-147878

(51) Int. Cl. G06T 7/00; G05B 23/02

(52) U.S. Cl. CPC G06T 7/0004; G05B 23/0205

(57) ABSTRACT

A visual recognition system configured to display an unreceived-signal sensor among a plurality of sensors that are inspection targets includes: a reception unit configured to be capable of receiving a sensor output transmitted from each of the plurality of sensors, the sensor output including identification information on the sensor; an unreceived-signal sensor identification unit configured to identify, among the plurality of sensors, the unreceived-signal sensor, the sensor output from which has not been received by the reception unit; and a display unit configured to display the unreceived-signal sensor identified by the unreceived-signal sensor identification unit, to be visually recognizable by a viewer.

### CROSS-REFERENCE TO RELATED APPLICATIONS

This application claims the benefit of priority to Japanese Patent Application Number 2021-147878 filed on Sep. 10, 2021. The entire contents of the above-identified application are hereby incorporated by reference.

### TECHNICAL FIELD

The present disclosure relates to a visual recognition system and a visual recognition method with which an unreceived-signal sensor among a plurality of sensors that are inspection targets is displayed.

### RELATED ART

A patrol inspection for a plant such as a thermal power plant include, for example, various operations such as palpation work, reading work for a meter such as an analog meter, abnormal sound detection, and steam leakage check. These operations may need to be carried out several times in shifts every day, and in a case where the operations are carried out by patrollers (persons), there arise problems of an increase in inspection costs, a lack of members to organize the patrol teams, and the like. There have been attempts to reduce the inspection cost of the patrol inspection. An example of this is by digitizing, with a wireless sensor, a measurement value obtained by an analog meter or the like and sending such digital data to a mobile terminal held by a patroller through wireless communications from the wireless sensor.

### SUMMARY

In a high sensor density location where a plurality of wireless sensors are provided in a predetermined area of a plant or the like, when there is an unreceived-signal sensor from which a signal cannot be received, it takes time to identify such an unreceived-signal sensor, meaning that the patrol inspection takes time. Furthermore, if there is an unreceived-signal sensor, there is a risk of insufficient inspection.

JP 2005-117424 A discloses a monitoring system including monitoring cameras and abnormality detection sensors. In the system, position information on a sensor that has detected abnormality is compared with map data. Then, the monitoring camera closest to the sensor that has detected abnormality is identified, and a video from such a monitoring camera is displayed. Unfortunately, the position information on an unreceived-signal sensor from which a signal cannot be received cannot be acquired from the unreceived-signal sensor. This means that the effectiveness of the disclosure disclosed in JP 2005-117424 A using the position information on the sensor that has detected abnormality is compromised.

In view of the above, an object of at least one embodiment of the present disclosure is to provide a visual recognition system and a visual recognition method with which an unreceived-signal sensor can be easily recognized so that inspection time can be shortened.

A visual recognition system configured to display an unreceived-signal sensor among a plurality of sensors that are inspection targets according to an embodiment of the present disclosure includes:

a reception unit configured to be capable of receiving a sensor output transmitted from each of the plurality of sensors, the sensor output including identification information on the sensor;

an unreceived-signal sensor identification unit configured to identify, among the plurality of sensors, the unreceived-signal sensor, the sensor output from which has not been received by the reception unit; and

a display unit configured to display the unreceived-signal sensor identified by the unreceived-signal sensor identification unit, to be visually recognizable by a viewer.

A visual recognition method for displaying an unreceived-signal sensor among a plurality of sensors that are inspection targets according to an embodiment of the present disclosure includes:

receiving a sensor output transmitted from each of the plurality of sensors, the sensor output including identification information on the sensor;

identifying, among the plurality of sensors, the unreceived-signal sensor, the sensor output from which has not been received in the receiving; and

displaying the unreceived-signal sensor identified in the identifying, to be visually recognizable by a viewer.

At least one embodiment of the present disclosure provides a visual recognition system and a visual recognition method with which an unreceived-signal sensor can be easily recognized so that inspection time can be shortened.

### BRIEF DESCRIPTION OF DRAWINGS

The disclosure will be described with reference to the accompanying drawings, wherein like numbers reference like elements.

FIG. 1 is a schematic configuration diagram schematically illustrating a configuration of a visual recognition system according to an embodiment of the present disclosure.

FIG. 2 is a flowchart illustrating an example of a visual recognition method according to an embodiment of the present disclosure.

FIG. 3 is an explanatory diagram illustrating display on a display unit according to an embodiment of the present disclosure.

FIG. 4 is an explanatory diagram illustrating display on the display unit according to an embodiment of the present disclosure.

FIG. 5 is an explanatory diagram illustrating display on the display unit according to an embodiment of the present disclosure.

FIG. 6 is an explanatory diagram illustrating an example of information on inspection targets.

FIG. 7 is an explanatory diagram illustrating display on the display unit according to an embodiment of the present disclosure.

FIG. 8 is an explanatory diagram illustrating display on the display unit according to an embodiment of the present disclosure.

FIG. 9 is an explanatory diagram illustrating display on the display unit according to an embodiment of the present disclosure.

FIG. 10 is a schematic configuration diagram schematically illustrating a configuration of a visual recognition system according to one embodiment of the present disclosure.

### DESCRIPTION OF EMBODIMENTS

Hereinafter, some embodiments of the present disclosure will be described with reference to the accompanying drawings. However, the dimensions, materials, shapes, relative arrangement, or the like of components described in the embodiments or illustrated in the drawings are not intended to limit the scope of the present disclosure and are merely illustrative examples.

For example, expressions indicating relative or absolute arrangement such as “in a direction,” “along a direction,” “parallel,” “orthogonal,” “center,” “concentric,” or “coaxial” shall not be construed as indicating only such arrangement in a strict literal sense but also as indicating a state of being relatively displaced by a tolerance, or by an angle or a distance as long as the same function can be obtained.

For example, expressions indicating a state of being equal such as “same,” “equal,” or “uniform” shall not be construed as indicating only a state of being strictly equal but also as indicating a state in which there is a tolerance or a difference as long as the same function can be obtained.

For example, expressions indicating a shape such as a rectangular shape or a cylindrical shape shall not be construed as only indicating a shape such as a rectangular shape or a cylindrical shape in a strict geometrical sense but also as indicating a shape including depressions, protrusions, chamfered corners, or the like as long as the same effect can be obtained.

On the other hand, expressions such as “comprising,” “including,” or “having” one component are not intended as exclusive expressions that exclude the presence of other components.

Note that the same reference signs may be assigned to similar configurations, with descriptions thereof being omitted.

### Visual Recognition System

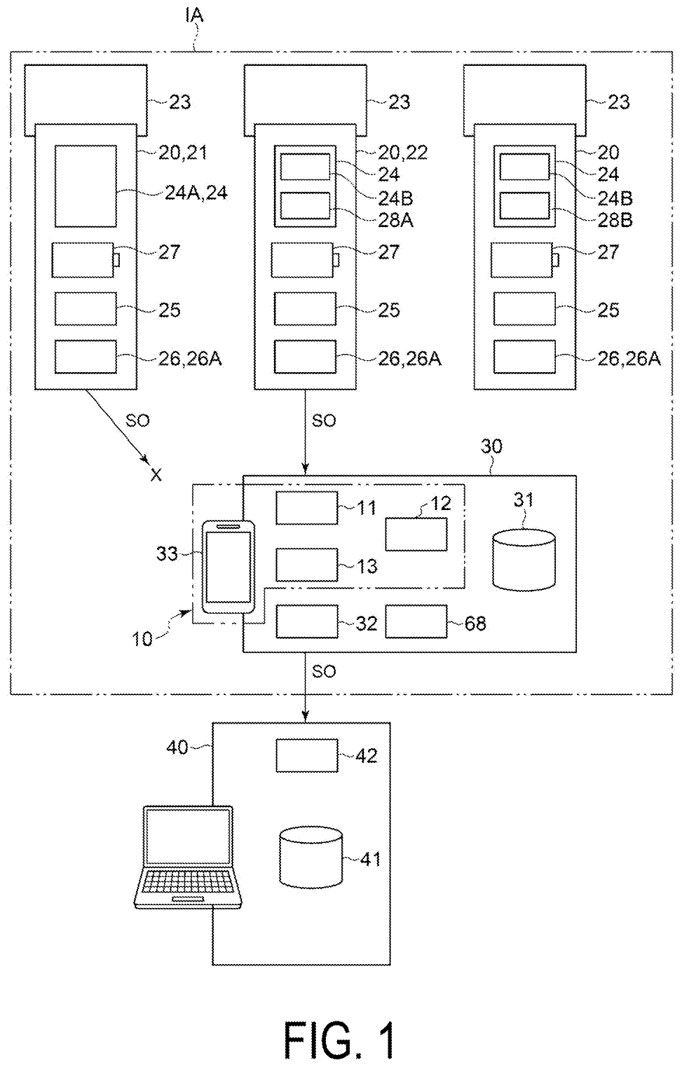

FIG. 1 is a schematic configuration diagram schematically illustrating a configuration of a visual recognition system according to one embodiment of the present disclosure. The visual recognition system 10 according to some embodiments displays an unreceived-signal sensor 21 among a plurality of sensors 20 that are inspection targets. As illustrated in FIG. 1, the visual recognition system 10 at least includes a reception unit 11 configured to be capable of receiving a sensor output SO sent from each of the plurality of sensors 20 that are the inspection targets.

Hereinafter, among the plurality of sensors 20, the sensor 20 the sensor output SO from which has not been received by the reception unit 11 is referred to as the unreceived-signal sensor 21, and the sensor 20 the sensor output SO from which has been received by the reception unit 11 is referred to as a received-signal sensor 22. Any area provided with the plurality of sensors 20 that are the inspection targets is referred to as an inspection area IA.

Each of the plurality of sensors 20 is attached to any of a plurality of devices 23 provided in the inspection area IA. Each of the plurality of sensors 20 is configured to be capable of acquiring the state of the device 23 to which the sensor 20 is attached, as a measurement value (measurement result). Each of the plurality of sensors 20 is configured to be capable of transmitting the sensor output SO. The sensor output SO includes sensor identification information (sensor ID) for identifying the sensor 20 that has output the sensor output SO, and the above measurement value acquired by the sensor 20 that has output the sensor output SO.

Each of the plurality of sensors 20 includes, as illustrated in FIG. 1: a measurement unit 24 configured to acquire the above measurement value; a storage unit 25 configured to store the above measurement value acquired by the measurement unit 24; and a transmission unit 26 configured to transmit, through wireless communications, the above measurement value stored in the storage unit 25, together with the above sensor identification information.

The measurement unit 24 is configured to be capable of measuring a desired physical quantity related to the device 23 to which the sensor 20 is attached (at least one of mechanical property, electromagnetic property, thermal property, acoustic property, scientific property, or spatial information or time information of the device 23).

The measurement unit 24 may include a digital meter 24A, an analog meter 24B, and the like. When the measurement unit 24 includes the digital meter 24A, a digital value detected by the digital meter 24A is stored in the storage unit 25.

When the measurement unit 24 includes the analog meter 24B, the measurement unit 24 preferably further includes: a converter 28A capable of outputting a digital value corresponding to an analog value detected by the analog meter 24B; an image capturing device (camera for example) 28B that captures an image of a meter portion displaying the analog value detected by the analog meter 24B; and the like. In this case, the digital value obtained by the converter 28A through the conversion, or captured image data (image or video) captured by the image capturing device 28B is stored in the storage unit 25.

The transmission unit 26 is wirelessly connected to the reception unit 11 using a first wireless communication system (Bluetooth (registered trademark), for example), and transmits the measurement value, acquired by the sensor 20, to a device including the reception unit 11 through wireless communications. In the embodiment illustrated in FIG. 1, the reception unit 11 is provided in a mobile terminal 30. The visual recognition system 10 further includes the mobile terminal 30 including the reception unit 11 and a display unit 13, and a terminal 40 configured to be capable of performing wireless communications with the mobile terminal 30.

A communication distance of electromagnetic waves transmitted from the transmission unit 26 is not long (within 10 meters or the like, for example). Thus, the device (mobile terminal 30) including the reception unit 11 moves to the vicinity of each of the plurality of sensors 20 to acquire the sensor output SO from each of the plurality of sensors 20. In the illustrated embodiment, the transmission unit 26 includes a radio tag 26A that is driven by power from a battery 27 installed, and is configured to output the sensor output SO in a form of electromagnetic waves.

An inspector carrying the mobile terminal 30 patrols the above inspection area IA once in every predetermined period, through patrol inspection in which he or she passes by each of the plurality of sensors 20. During the patrol inspection, the mobile terminal 30 enters a range of a communication distance of the electromagnetic waves transmitted from the transmission unit 26 of each sensor 20, and thus the reception unit 11 of the mobile terminal 30 receives the sensor output SO from the transmission unit 26.

The mobile terminal 30 is wirelessly connected to the terminal 40 under a second wireless communication system (Wi-Fi (registered trademark), for example) featuring a higher communication speed and a longer communication distance than the above first wireless communication system. The sensor output SO is sent from the mobile terminal 30 to the terminal 40 through wireless communications. Note that the transmission of information between the mobile terminal 30 and the terminal 40 is not limited to the second wireless communication system described above. The transmission of information between the mobile terminal 30 and the terminal 40 may be implemented with wireless communications other than those under the second wireless communication system, wired communications (Ethernet (registered trademark), for example), or a storage medium such as an SD card. The mobile terminal 30 and the terminal 40 may include a wired connection unit enabling the wired communications, and a storage medium connection unit to and from which the storage medium can be connected and disconnected.

The mobile terminal 30 further includes a first storage unit 31 that stores the sensor output SO, and a first communication unit 32 that is configured to be capable of performing wireless communications with the terminal 40 under the above second wireless communication system. The terminal 40 further includes a second storage unit 41 that stores the sensor output SO, and a second communication unit 42 that is configured to be capable of performing wireless communications with the mobile terminal 30 under the above second wireless communication system.

An unreceived-signal sensor identification unit 12 compares the plurality of sensors 20 that are the inspection targets with the received-signal sensor 22 the sensor output SO from which has been received by the reception unit 11, and identifies the sensor 20, among the plurality of sensors 20, other than the received-signal sensor 22 as the unreceived-signal sensor 21. In the illustrated embodiment, the mobile terminal 30 includes the unreceived-signal sensor identification unit 12, the unreceived-signal sensor identification unit 12 may alternatively be included in the terminal 40.

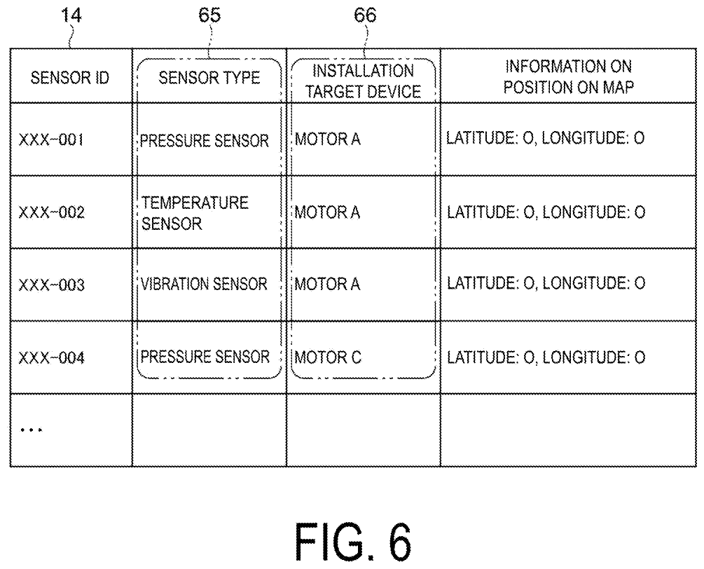

Information 14 on the inspection targets (see FIG. 6) during the patrol inspection is set and is stored in the first storage unit 31 in advance, that is, before the patrol inspection. The information 14 on the inspection targets sensor identification information on each of the plurality of sensors 20 that are the inspection targets. The unreceived-signal sensor identification unit 12 refers to the information 14 on the inspection targets stored in the first storage unit 31, compares the sensor identification information of each of the plurality of sensors 20 included in the above information 14 on the inspection targets with the sensor identification information on each of the received-signal sensor 22 received by the reception unit 11, and identifies the sensor 20 without the matching sensor identification information as the unreceived-signal sensor 21.

The display unit 13 is configured to display the unreceived-signal sensor 21 identified by the unreceived-signal sensor identification unit 12, to be visually recognizable by a viewer. In the illustrated embodiment, the display unit 13 includes a display screen 33 provided to the mobile terminal 30, and is configured to cause the display screen 33 to display the unreceived-signal sensor 21.

As will be described in detail below, the display unit 13 may display only the unreceived-signal sensor 21 among the plurality of sensors 20 on the display screen 33, or may display both the unreceived-signal sensor 21 and the received-signal sensor 22 on the display screen 33. When the unreceived-signal sensor 21 and the received-signal sensor 22 are both displayed on the display screen 33, the unreceived-signal sensor 21 may be displayed to be highlighted compared with the received-signal sensor 22, to be visually recognizable by the viewer. The highlighted display includes making the display (such as a character string) representing the unreceived-signal sensor 21 highlighted, displayed in italic letters, displayed in bold letters, displayed using a color different from that for the received-signal sensor 22, blink, or the like. Furthermore, when the unreceived-signal sensor 21 and the received-signal sensor 22 are both displayed on the display screen 33, at least one of the unreceived-signal sensor 21 or the received-signal sensor 22 may be provided with an identification mark so that the unreceived-signal sensor 21 and the received-signal sensor 22 can be distinguished from each other, to be visually recognizable by the viewer. The identification mark includes a frame, decoration, or the like surrounding the display (such as a character string) indicating at least one of the unreceived-signal sensor 21 and the received-signal sensor 22.

The visual recognition system 10 according to some embodiments includes the reception unit 11 described above, the unreceived-signal sensor identification unit 12 described above, and the display unit 13 described above, as illustrated in FIG. 1. With the configuration described above, the unreceived-signal sensor identification unit 12 can identify, as the unreceived-signal sensor 21, the sensor 20 other than the received-signal sensor 22 the sensor output SO from which has been received by the reception unit 11 among the plurality of sensors 20 that are the inspection targets. With the unreceived-signal sensor 21 identified by the unreceived-signal sensor identification unit 12 displayed on the display unit 13 to be visually recognizable by the viewer, the viewer viewing the display unit 13 can recognize the unreceived-signal sensor 21. In this case, countermeasures for resolving the unreceived-signal state of the unreceived-signal sensor 21, such as patrolling by an inspector near the unreceived-signal sensor 21 in an attempt to retry the reception, can be swiftly taken, whereby the problem related to the unreceived-signal sensor 21 can be resolved in a shorter period of time and thus the inspection time can be shortened.

In some embodiments, as illustrated in FIG. 1, the visual recognition system 10 described above includes the mobile terminal 30 including at least the reception unit 11 and the display unit 13 described above. With the configuration described above, the unreceived-signal sensor 21 is displayed, on the display unit 13 of the mobile terminal 30, to be visually recognizable by the viewer. Thus, the inspector (viewer) carrying the mobile terminal 30 can be prompted to take countermeasures for resolving the unreceived-signal state of the unreceived-signal sensor 21. Thus, the inspector can swiftly take measures to reduce the unreceived-signal sensor 21 during the inspection, whereby the inspection time can be shortened.

### Visual Recognition Method

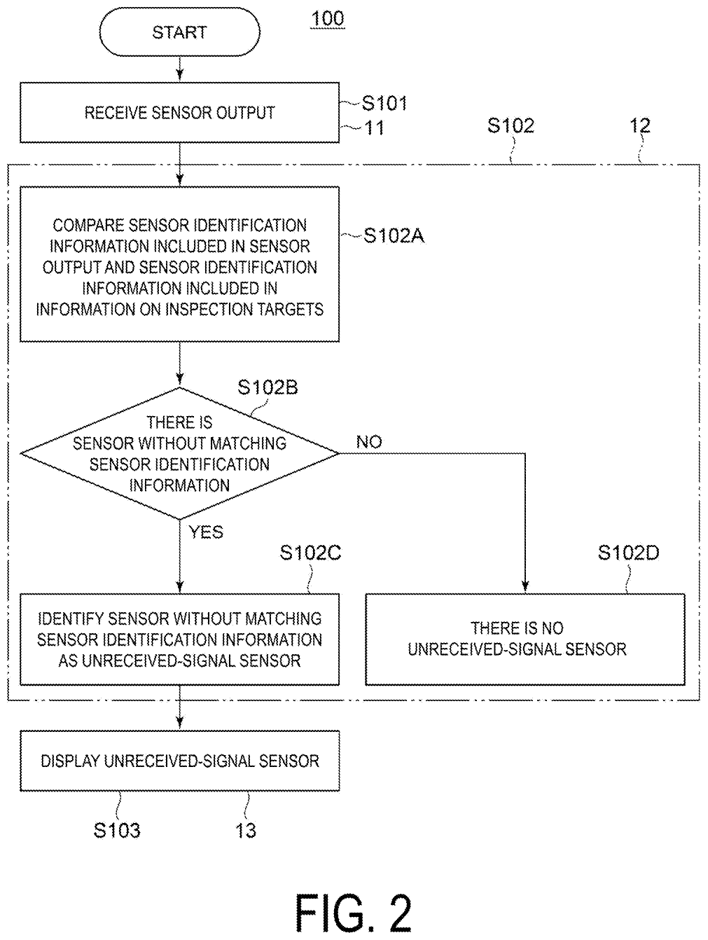

FIG. 2 is a flowchart illustrating an example of a visual recognition method according to an embodiment of the present disclosure. A visual recognition method 100 according to some embodiments is a method for displaying the unreceived-signal sensor 21 among the plurality of sensors 20 that are the inspection targets. As illustrated in FIG. 2, the visual recognition method 100 includes a reception step S101, an unreceived-signal sensor identification step S102, and a display step S103. The reception step S101, the unreceived-signal sensor identification step S102, and the display step S103 are each preferably executed by the inspector carrying the mobile terminal 30 during the patrol inspection.

In the illustrated embodiment, some steps (the reception step S101, the unreceived-signal sensor identification step S102, and the display step S103) in the visual recognition method 100 are executed by the visual recognition system 10. It should be noted that some steps in the visual recognition method 100 may be executed by an apparatus or device other than the visual recognition system 10, or may be performed manually.

In the reception step S101, the sensor output SO, including the identification information on the sensor 20, transmitted from each of the plurality of sensors 20 that are the inspection targets is received. In the illustrated embodiment, the reception unit 11 of the mobile terminal 30 executes the reception step S101.

In the unreceived-signal sensor identification step S102, the unreceived-signal sensor 21 the sensor output SO from which has not been received in the reception step S101 among the plurality of sensors 20 is identified. In the illustrated embodiment, the unreceived-signal sensor identification unit 12 of the mobile terminal 30 executes the unreceived-signal sensor identification step S102. In the unreceived-signal sensor identification step S102, the sensor identification information on each of the plurality of sensors 20 included in the information 14 on the inspection targets is compared with the sensor identification information on the received-signal sensor 22 received by the reception unit 11 (S102A). When a result of the comparison between these pieces of sensor identification information indicates that there is a sensor 20 without the matching sensor identification information (“YES” in S102B), the sensor 20 without the matching sensor identification information is identified as the unreceived-signal sensor 21 (S102C). When a result of the comparison between these pieces of sensor identification information indicates that there is no sensor 20 without the matching sensor identification information (“NO” in S102B), there is no unreceived-signal sensor 21 (S102D). In this case, the display step S103 may not be executed.

In the display step S103, the unreceived-signal sensor 21 identified in the unreceived-signal sensor identification step S102 is displayed to be visually recognizable by the viewer. In the illustrated embodiment, the display unit 13 of the mobile terminal 30 executes the display step S103. The display unit 13 may be configured to execute the display step S103 in response to a request from the inspector (viewer) carrying the mobile terminal 30.

With the method described above, in the unreceived-signal sensor identification step S102, the unreceived-signal sensor 21 can be identified as the sensor 20 other than the received-signal sensor 22 the sensor output SO from which has been received in the reception step S101 among the plurality of sensors 20 that are the inspection targets. In the display step S103, the unreceived-signal sensor 21 identified in the unreceived-signal sensor identification step S102 is displayed to be visually recognizable by the viewer, so that the viewer viewing the display can recognize the unreceived-signal sensor 21. In this case, countermeasures for resolving the unreceived-signal state of the unreceived-signal sensor 21, such as patrolling by an inspector near the unreceived-signal sensor 21 in an attempt to retry the reception, can be swiftly taken, whereby the problem related to the unreceived-signal sensor 21 can be resolved in a shorter period of time and thus the inspection time can be shortened.

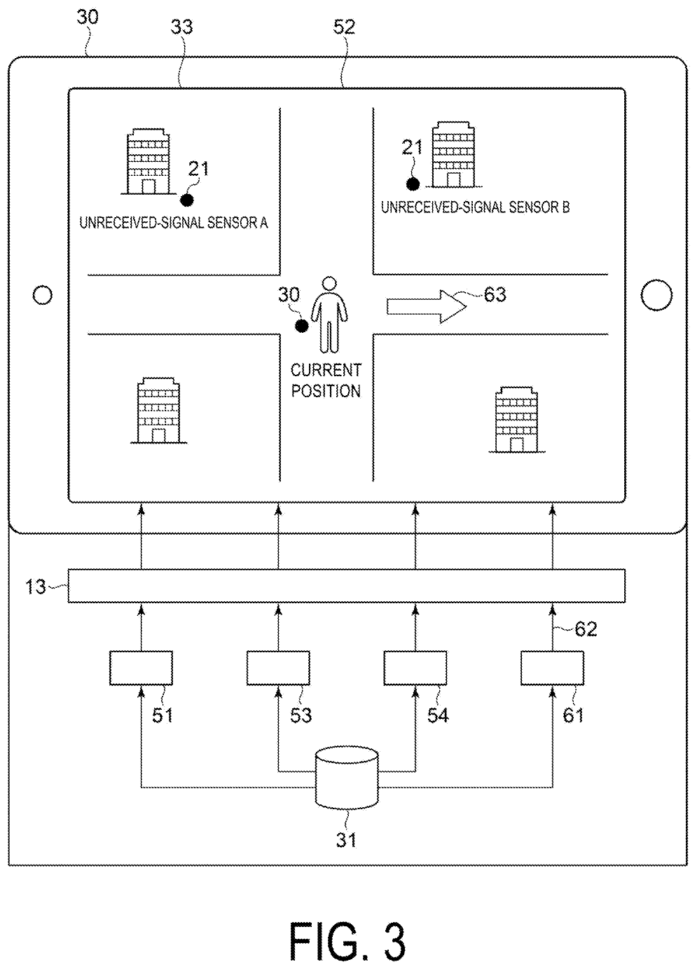

FIG. 3 is an explanatory diagram illustrating display on the display unit according to an embodiment of the present disclosure. In some embodiments, the mobile terminal 30 described above further includes a map acquisition unit 51 configured to be capable of acquiring a map 52 of the inspection area IA including the unreceived-signal sensor 21, as illustrated in FIG. 3. The display unit 13 described above is configured to be capable of displaying the unreceived-signal sensor 21 with the position overlapping the map 52 acquired by the map acquisition unit 51.

The map acquisition unit 51 acquires, from the first storage unit 31, the map 52 (map data) stored in the first storage unit 31 in advance, that is, before the patrol inspection. The display unit 13 displays the map 52, acquired by the map acquisition unit 51, on the display screen 33. The map 52 (map data) may be two-dimensional map data such as a plan view, or may be three-dimensional map data (3D map) that includes three-dimensional information and can be three-dimensionally displayed on the display screen 33.

The mobile terminal 30 further includes a first position acquisition unit 53 configured to be capable of acquiring a position of the unreceived-signal sensor 21 on the map 52. The information 14 on the inspection targets described above includes the position information on each of the plurality of sensors 20, and includes position information associated with the sensor identification information for each sensor 20. The position information on each of the plurality of sensors 20 may be two-dimensional or three-dimensional position coordinates (such as latitude and longitude), in a coordinate system, indicating a position of each sensor 20 on the earth, or may be two-dimensional or three-dimensional position coordinates in a map coordinate system indicating a position of each sensor 20 on the map 52.

The first position acquisition unit 53 acquires the position (position information) of the unreceived-signal sensor 21 on the map 52, from the information 14 on the inspection targets stored in the first storage unit 31. The display unit 13 displays the unreceived-signal sensor 21 with the position overlapping the map 52 on the display screen 33, while taking into account the position (position information) of the unreceived-signal sensor 21 on the map 52 acquired by the first position acquisition unit 53.

With the configuration described above, the unreceived-signal sensor 21 is displayed while being positioned on the map 52 of the inspection area IA displayed on the display unit 13, so that the viewer (inspector) viewing the display unit 13 can easily and swiftly recognize the position of the unreceived-signal sensor 21. Countermeasures for resolving the unreceived-signal state of the unreceived-signal sensor 21 can be swiftly taken by the inspector who has recognized the position of the unreceived-signal sensor 21, whereby the problem related to the unreceived-signal sensor 21 can be resolved in a shorter period of time and thus the inspection time can be shortened.

In some embodiments, the map acquisition unit 51 described above is configured to acquire the map 52 of the inspection area IA including the unreceived-signal sensor 21 and the mobile terminal 30. The display unit 13 described above is configured to be capable of displaying the unreceived-signal sensor 21 and the mobile terminal 30 with the positions overlapping the map 52 acquired by the map acquisition unit 51.

The mobile terminal 30 further includes a second position acquisition unit 54 configured to be capable of acquiring a position of the mobile terminal 30 on the map 52. The second position acquisition unit 54 may be configured to acquire position coordinates (such as latitude and longitude) of the mobile terminal 30 in the above coordinate system, and convert the position coordinates in the acquired coordinate system into position coordinates in the map coordinate system (position on the map 52).

The display unit 13 displays the mobile terminal 30 with the position overlapping the map 52 on the display screen 33, while taking into account the position of the mobile terminal 30 on the map 52 acquired by the second position acquisition unit 54.

With the configuration described above, the unreceived-signal sensor 21 and the mobile terminal 30 are displayed while being positioned on the map 52 of the inspection area IA displayed on the display unit 13, so that the viewer (inspector) viewing the display unit 13 can easily and swiftly recognize the position of the unreceived-signal sensor 21.

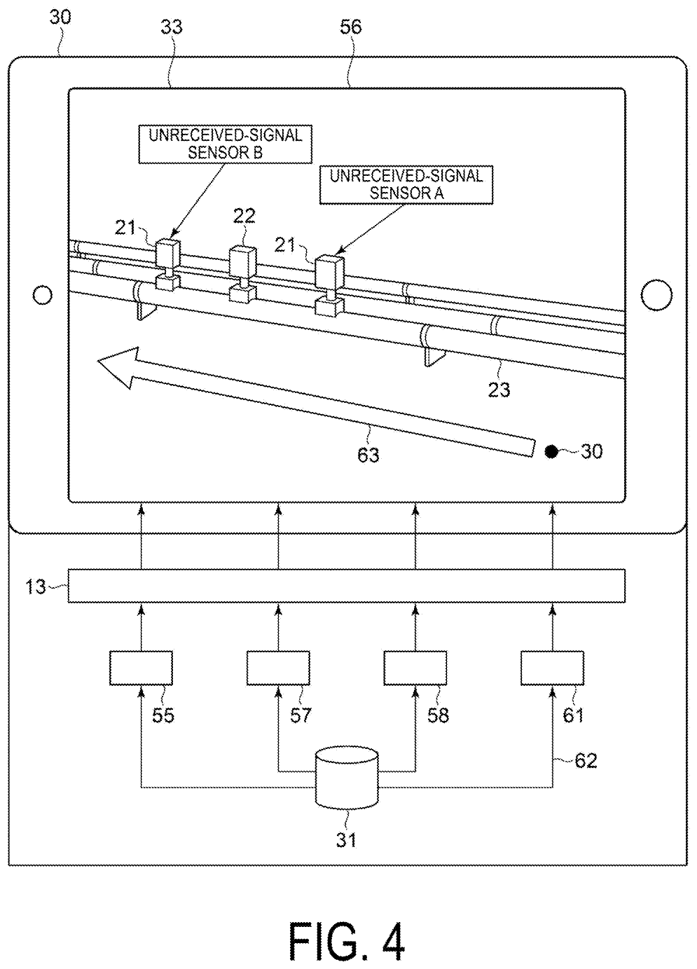

FIG. 4 is an explanatory diagram illustrating display on the display unit according to an embodiment of the present disclosure. In some embodiments, the mobile terminal 30 described above further includes an image capturing unit 55 configured to be capable of capturing images, as illustrated in FIG. 4. The display unit 13 described above is configured to be capable of displaying the unreceived-signal sensor 21 with the position overlapping an image 56 captured by the image capturing unit 55.

The mobile terminal 30 further includes: a third position acquisition unit 57 configured to be capable of acquiring the position (position information) of the unreceived-signal sensor 21 in the coordinate system; and a position/orientation acquisition unit 58 configured to acquire a position (position information) of the mobile terminal 30 in the above coordinate system and an orientation in which the mobile terminal 30 (specifically, the image capturing unit 55) is oriented.

The third position acquisition unit 57 acquires the position (position information) of the unreceived-signal sensor 21 in the above coordinate system, from the information 14 on the inspection targets stored in the first storage unit 31. The display unit 13 displays the unreceived-signal sensor 21 with the position overlapping the image 56 on the display screen 33, while taking into account the position (position information) of the unreceived-signal sensor 21 in the above coordinate system acquired by the third position acquisition unit 57 and the position (position information) of the mobile terminal 30 in the above coordinate system and the orientation in which the mobile terminal 30 is oriented acquired by the position/orientation acquisition unit 58. The image 56 displayed on the display screen 33 by the display unit 13 is preferably a real-time image. In this case, the image 56 displayed on the display screen 33 by the display unit 13 changes to follow changes in the position and orientation of the mobile terminal 30, so that the viewer viewing the display screen 33 can easily recognize the actual position of the unreceived-signal sensor 21.

With the configuration described above, the unreceived-signal sensor 21 is displayed while being positioned on the image 56 captured by the image capturing unit 55 and displayed on the display unit 13, so that the viewer (inspector) viewing the display unit 13 can easily and swiftly recognize the position of the unreceived-signal sensor 21, compared with the case of displaying on the map 52. Then, countermeasures for resolving the unreceived-signal state of the unreceived-signal sensor 21 can be swiftly taken by the inspector who has recognized the position of the unreceived-signal sensor 21, whereby the problem related to the unreceived-signal sensor 21 can be resolved in a shorter period of time and thus the inspection time can be shortened.

In some embodiments, as illustrated in FIGS. 3 and 4, the mobile terminal 30 described above further includes a route information acquisition unit 61 configured to be capable of acquiring route information 62 being information on a route 63 of the inspector. The display unit 13 described above is configured to be capable of displaying the route 63 of the inspector together with the position of the unreceived-signal sensor 21.

The route information 62 may include position information on a plurality of points on the route 63 of the inspector during the patrol inspection. The route information 62 is stored in the first storage unit 31 in advance, that is, before the patrol inspection. The route information acquisition unit 61 acquires the route information 62 from the first storage unit 31. The display unit 13 displays the route 63 of the inspector on the map 52 or the image 56 displayed on the display screen 33, while taking into account the route information 62 acquired by the route information acquisition unit 61.

With the configuration described above, the route 63 of the inspector is displayed on the display unit 13 together with the position of the unreceived-signal sensor 21, so that the viewer (inspector) viewing the display unit 13 can easily and swiftly recognize the position of the unreceived-signal sensor 21. Furthermore, with the route 63 of the inspector displayed on the display unit 13, the viewer (inspector) viewing the display unit 13 can be swiftly guided to the next inspection point, whereby the inspection time can be shortened.

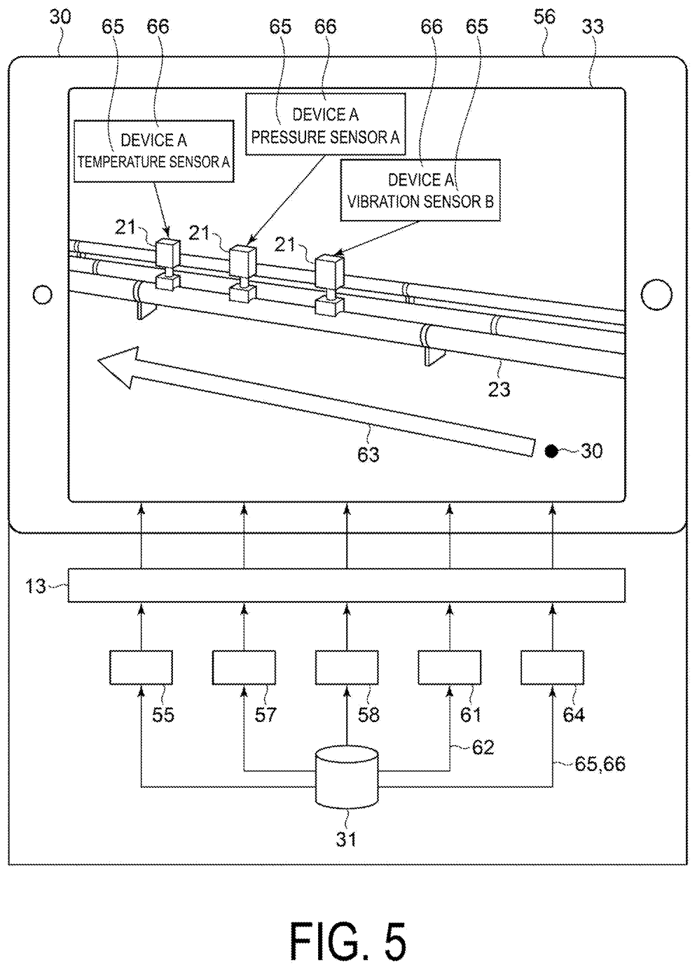

FIG. 5 is an explanatory diagram illustrating display on the display unit according to an embodiment of the present disclosure. FIG. 6 is an explanatory diagram illustrating an example of information on inspection targets. In some embodiments, the mobile terminal 30 described above further includes an accompanying information acquisition unit 64 configured to be capable of acquiring at least one of sensor accompanying information 65 being information on each of the plurality of sensors 20, or device accompanying information 66 being information on the devices 23 to which the plurality of sensors 20 are respectively attached. The display unit 13 described above is configured to be capable of displaying at least one of the sensor accompanying information 65 or the device accompanying information 66, together with the position of the unreceived-signal sensor 21.

In the illustrated embodiment, the information 14 on the inspection targets described above includes the sensor accompanying information 65 and the device accompanying information 66. In the information 14 on the inspection targets, the sensor accompanying information 65 and the device accompanying information 66 are associated with the sensor identification information on each sensor 20. The sensor accompanying information 65 includes the type of the sensor, such as a temperature sensor or a pressure sensor. The device accompanying information 66 includes the name of the devices 23, identification information on the devices 23 (device ID), and the like.

The accompanying information acquisition unit 64 acquires the information 14 on the inspection targets (the sensor accompanying information 65 and the device accompanying information 66) from the first storage unit 31. The display unit 13 displays the sensor accompanying information 65 and the device accompanying information 66 on the display screen 33 on the map 52 or the image 56 displayed on the display screen 33, while taking into account the sensor accompanying information 65 and the device accompanying information 66 acquired by the accompanying information acquisition unit 64.

With the configuration described above, the sensor accompanying information 65 and the device accompanying information 66 are displayed on the display unit 13 together with the position of the unreceived-signal sensor 21, so that the viewer (inspector) viewing the display unit 13 can easily and swiftly recognize the position of the unreceived-signal sensor 21 and the position of the device 23 to which the unreceived-signal sensor 21 is attached. In particular, the sensor accompanying information 65 and the device accompanying information 66 are effectively displayed for identifying the unreceived-signal sensor 21 among the plurality of sensors 20 in a location with a high sensor density in which the plurality of sensors 20 are arranged.

### List Display

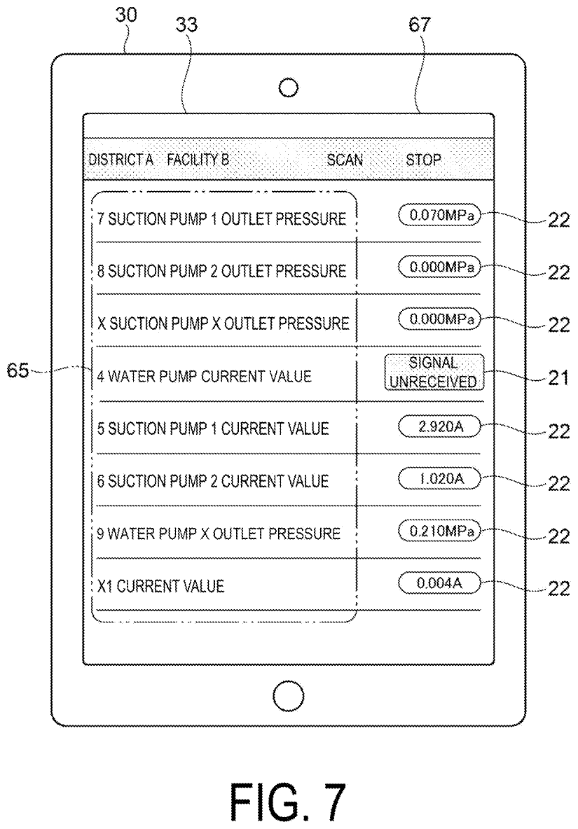

FIG. 7 is an explanatory diagram illustrating display on the display unit according to an embodiment of the present disclosure.

In some embodiments, the display unit 13 described above is configured to be capable of displaying the unreceived-signal sensor 21 and the received-signal sensor 22 in a common list 67. The display unit 13 described above is configured to be capable of displaying the unreceived-signal sensor 21 in a mode different from that of the received-signal sensor 22 in the common list 67.

The display unit 13 displays the common list 67 on the display screen 33. In the illustrated embodiment, the display unit 13 is configured to display, on the common list 67, a measurement value (measurement result) acquired by the received-signal sensor 22, as one display indicating the received-signal sensor 22. The display unit 13 displays, on the common list 67, a character string such as “unreceived-signal” indicating the unreceived-signal sensor 21 for example, as one display indicating the unreceived-signal sensor 21.

On the common list 67, the display unit 13 may display all of the sensors 20 present in the inspection area IA, or may display the sensor 20 present in one of a plurality of regions into which the inspection area IA is segmented. In a certain embodiment, the display unit 13 may display the sensor 20 present in a region including the mobile terminal 30, among the plurality of regions into which the inspection area IA is segmented, while taking into account the position information on the mobile terminal 30.

With the configuration described above, the display unit 13 displays the unreceived-signal sensor 21 and the received-signal sensor 22 on the common list 67, so that whether there is an unreceived-signal sensor 21 on the common list 67 can be easily recognized. Thus, a failure to receive the sensor output SO from the plurality of sensors 20 displayed on the common list 67 can be suppressed.

### Notification Unit

In some embodiments, the mobile terminal 30 described above further includes a notification unit 68 configured to be capable of outputting a notification sound or voice to issue a notification indicating that the unreceived-signal sensor identification unit 12 has identified the unreceived-signal sensor 21 as illustrated in FIG. 1.

In a certain embodiment, the unreceived-signal sensor identification unit 12 is configured to identify, when the mobile terminal 30 passes through one of the plurality of regions into which the inspection area IA is segmented, the unreceived-signal sensor 21 in the passed region. In this case, the notification unit 68 outputs the notification sound or voice, to notify the inspector of the fact that the unreceived-signal sensor 21 exists in the passed region, whereby a failure to receive the sensor output SO from the plurality of sensors 20 can be suppressed.

In a certain embodiment, the unreceived-signal sensor identification unit 12 may, when the mobile terminal 30 has separated from the sensor 20 by a predetermined distance (a communication distance of the electromagnetic waves transmitted from the transmission unit 26, for example) without receiving the sensor output SO from the sensor 20, identify this sensor 20 as the unreceived-signal sensor 21. In this case, the notification unit 68 that has separated from the unreceived-signal sensor 21 by the above predetermined distance outputs the notification sound or voice, and thus can immediately notify the inspector that there is an unreceived-signal sensor 21.

In a certain embodiment, the unreceived-signal sensor identification unit 12 may be configured to identify the unreceived-signal sensor 21 once in every predetermined period.

With the configuration described above, the notification unit 68 outputs the notification sound or voice, so that the inspector can recognize that there is an unreceived-signal sensor 21 without constantly viewing the display unit 13. Thus, a failure to receive the sensor output SO from the plurality of sensors 20 that are the inspection targets can be suppressed.

### Displaying Countermeasure

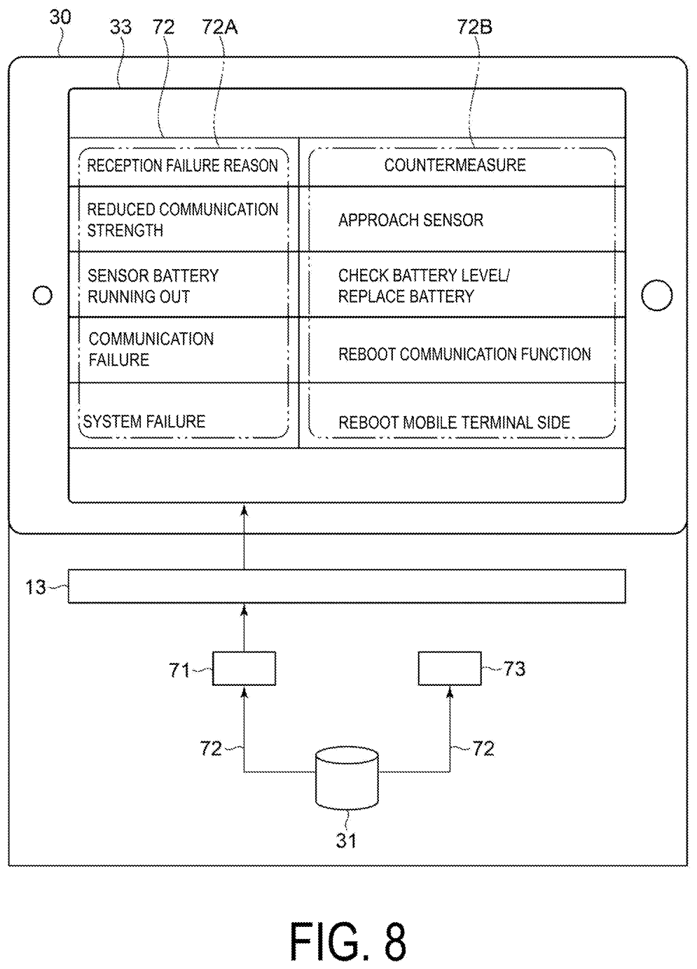

FIG. 8 is an explanatory diagram illustrating the display on the display unit according to an embodiment of the present disclosure. In some embodiments, the mobile terminal 30 described above further includes a countermeasure acquisition unit 71 that acquires information 72 on a countermeasure for enabling the reception of the sensor output SO from the unreceived-signal sensor 21 as illustrated in FIG. 8. The display unit 13 described above is configured to be capable of displaying the information 72 on the countermeasure, when the unreceived-signal sensor identification unit 12 identifies the unreceived-signal sensor 21.

The information 72 on a countermeasure includes a reception failure reason 72A and a countermeasure 72B associated with the reception failure reason. The reception failure reason 72A includes reduced communication strength, the battery of the sensor 20 running out, communication failure, system failure of the mobile terminal 30, and the like. The information 72 on the countermeasure is set in advance, that is, before the patrol inspection and stored in the first storage unit 31. The countermeasure acquisition unit 71 acquires the information 72 on the countermeasure from the first storage unit 31. When the unreceived-signal sensor identification unit 12 identifies the unreceived-signal sensor 21, the display unit 13 displays a character string indicating the above reception failure reason 72A and the above countermeasure 72B on the display screen 33, while taking into account the information 72 on the countermeasure acquired by the countermeasure acquisition unit 71.

With the configuration described above, when the unreceived-signal sensor identification unit 12 identifies the unreceived-signal sensor 21, the display unit 13 displays a guidance (the information 72 on the countermeasure), so that the viewer (inspector) viewing the display unit 13 can swiftly take the countermeasure for resolving the unreceived-signal state of the unreceived-signal sensor 21. Thus, the problem related to the unreceived-signal sensor 21 can be resolved in a shorter period of time and thus the inspection time can be shortened.

In some embodiments, as illustrated in FIG. 8, the mobile terminal 30 described above further includes an input unit 73 configured to enable input of at least one of the countermeasure 72B that has enabled the reception from the sensor output SO from the unreceived-signal sensor 21 by the reception unit 11, or a reason (reception failure reason 72A) associated with the countermeasure 72B.

The above countermeasure 72B and the above reception failure reason 72A input to the input unit 73 are stored in the first storage unit 31, and thus the countermeasure 72B and the reception failure reason 72A are accumulated in the first storage unit 31. The above countermeasure 72B and the above reception failure reason 72A may be stored in the first storage unit 31 in association with the type of the sensor 20 or the identification information on the sensor 20.

As illustrated in FIG. 8, the mobile terminal 30 described above may further include a countermeasure update unit 74 that updates the information 72 on the countermeasure described above, while taking into account the above countermeasure 72B and the above reception failure reason 72A accumulated in the first storage unit 31. The update by the countermeasure update unit 74 includes changing the display order of countermeasure 72B and the reception failure reason 72A on the display screen 33, in accordance with the frequency of the countermeasure 72B and the reception failure reason 72A input to the input unit 73.

With the configuration described above, the countermeasure that has enabled the reception of the sensor output SO from the unreceived-signal sensor 21 by the reception unit 11 and the reason 72A associated with the countermeasure 72B are stored and accumulated, so that a main reason that has resulted in the unreceived-signal sensor 21 and the effective countermeasure for the main reason can be recognized. With this configuration, a more appropriate guidance (information 72 on the countermeasure) can be displayed on the display unit 13 in response to the identification of the unreceived-signal sensor 21, whereby the problem related to the unreceived-signal sensor 21 can be resolved in a shorter period of time and thus the inspection time can be shortened.

Displaying Sensor with High Reception Difficulty

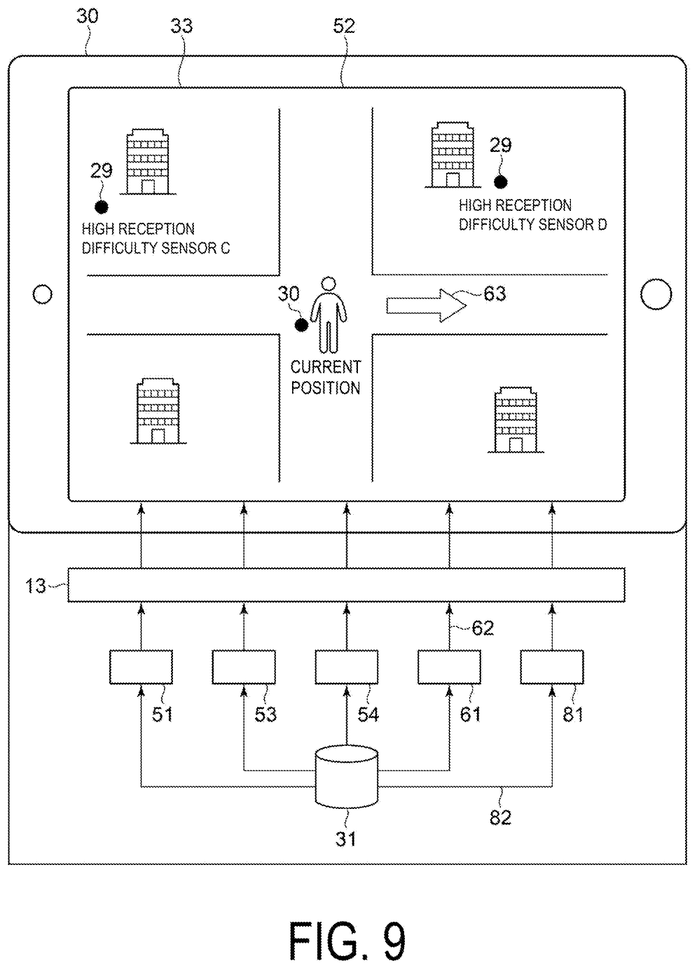

FIG. 9 is an explanatory diagram illustrating the display on the display unit according to an embodiment of the present disclosure. In some embodiments, as illustrated in FIG. 9, the mobile terminal 30 described above further includes a reception difficulty information acquisition unit 81 that acquires reception difficulty information 82 indicating the level of difficulty of reception from each of the plurality of sensors 20 that are the inspection targets. The display unit 13 described above is configured to display a sensor 29 with a high reception difficulty, among the plurality of sensors 20, to be visually recognizable by the viewer.

The reception difficulty information 82 is set and stored in the first storage unit 31 in advance, that is, before the patrol inspection. The reception difficulty information 82 may indicate the sensor 29 with a high reception difficulty, as the sensor 20 the received signal strength of which has been found to be equal to or lower than a threshold, through measurement on the received signal strength of each of the plurality of sensors 20. The reception difficulty information 82 may indicate the sensor 29 with a high reception difficulty, as the sensor 20 that has been subjected to the factor of reducing the communication strength, as indicated by the above reception failure reason accumulated in the first storage unit 31, at a frequency that is equal to or higher than a predetermined frequency.

With the configuration described above, the following effect can be achieved. Specifically, the sensor 29 with a high reception difficulty has low communication strength at the location at which the sensor 29 is installed, and thus is likely to be the unreceived-signal sensor 21. With the sensor 29 that is likely to be the unreceived-signal sensor 21 displayed in advance on the display unit 13 of the mobile terminal 30 to be visually recognizable by the viewer, the viewer (inspector) can be prompted to patrol near the sensor 29 with the high reception difficulty. With the inspector patrolling near the sensor 29 with a high reception difficulty, a distance between the reception unit 11 and the sensor 29 with a high reception difficulty can be made short, whereby transition of the sensor 29 with a high reception difficulty to the unreceived-signal sensor 21 can be suppressed. Thus, the number of unreceived-signal sensors 21 can be reduced, whereby the inspection time can be reduced.

In some embodiments described above, the visual recognition system 10 refers to the information stored in the first storage unit 31, but these pieces of information may be stored in the second storage unit 41. Thus, the visual recognition system 10 may refer to the information stored in the second storage unit 41.

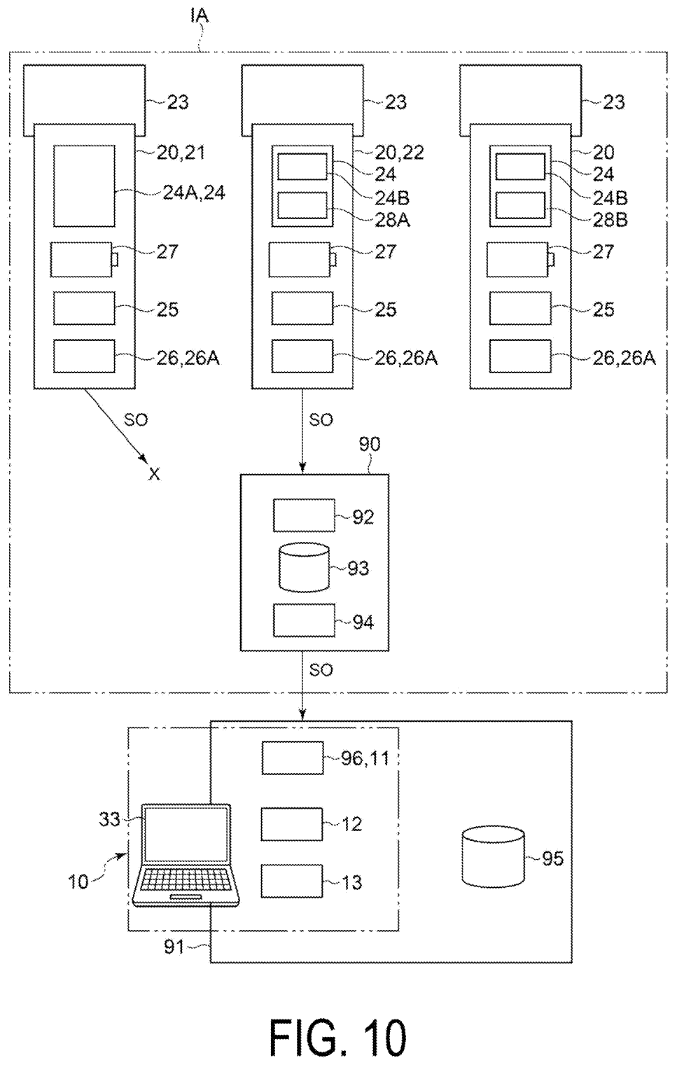

FIG. 10 is a schematic configuration diagram schematically illustrating a configuration of a visual recognition system according to one embodiment of the present disclosure. The visual recognition system 10 according to some embodiments includes the reception unit 11 described above, the unreceived-signal sensor identification unit 12 described above, and the display unit 13 described above, as illustrated in FIG. 10. The visual recognition system 10 further includes: a moving body 90 including the reception unit 11; and a display device 91 that is configured to be a member provided separately from the moving body 90, the display device 91 including the display unit 13. The display screen 33 described above is provided to the display device 91.

The moving body 90 is configured to move along a patrol route set in advance in the inspection area IA. The moving body 90 may be a maintenance/inspection robot moving on the ground such as an automatic guided vehicle (AGV) for example, or may be a maintenance/inspection robot of a flying type such as an unmanned aerial vehicle (UAV) an example of which including a drone. Alternatively, the moving body 90 may be a vehicle that carries a person. The moving body 90 may be configured to move automatically along the patrol route, or may be configured to be remotely controlled by an operator or the like.

The transmission unit 26 is wirelessly connected to a moving body side reception unit 92 included in the moving body 90 using a first wireless communication system (Bluetooth (registered trademark), for example), and transmits the measurement value, acquired by the sensor 20, to the moving body 90 through wireless communications.

The patrol inspection is performed with the moving body 90 patrolling the above inspection area IA once in every predetermined period, while passing by each of the plurality of sensors 20. During the patrol inspection, the moving body 90 enters a range of a communication distance of the electromagnetic waves transmitted from the transmission unit 26 of each sensor 20, and thus the moving body side reception unit 92 of the moving body 90 receives the sensor output SO from the transmission unit 26.

The moving body 90 is wirelessly connected to the display device 91 under the second wireless communication system (Wi-Fi (registered trademark), for example) featuring a longer communication distance than the above first wireless communication system. The sensor output SO is sent from the moving body 90 to the display device 91 through wireless communications. Note that the transmission of information between the moving body 90 and the display device 91 is not limited to the second wireless communication system described above. The transmission of information between the moving body 90 and the display device 91 may be implemented with wireless communications other than those under the second wireless communication system, wired communications (Ethernet (registered trademark), for example), or a storage medium such as an SD card. The moving body 90 and the display device 91 may include a wired connection unit enabling the wired communications, and a storage medium connection unit to and from which the storage medium can be connected and disconnected.

The moving body 90 further includes a moving body side storage unit 93 that stores the sensor output SO, and a moving body side communication unit 94 that is configured to be capable of performing wireless communications with the display device 91 under the above second wireless communication system. The display device 91 further includes a display device side storage unit 95 that stores the sensor output SO, and a display device side communication unit 96 (the reception unit 11 described above) that is configured to be capable of performing wireless communications with the moving body 90 under the second wireless communication system.

In some embodiments described above, reference is made to the information stored in the first storage unit 31, but these pieces of information may be stored in the display device side storage unit 95. Thus, the reference may be made to the information stored in the display device side storage unit 95.

As illustrated in FIG. 10, the display device 91 may include the unreceived-signal sensor identification unit 12 described above. The display device 91 may include the map acquisition unit 51, the first position acquisition unit 53, the second position acquisition unit 54, the image capturing unit 55, the third position acquisition unit 57, the position/orientation acquisition unit 58, the route information acquisition unit 61, the accompanying information acquisition unit 64, the notification unit 68, the countermeasure acquisition unit 71, the input unit 73, the countermeasure update unit 74, the reception difficulty information acquisition unit 81, or the like.

With the configuration described above, the moving body 90 including the reception unit 11 patrols in the inspection area IA provided with the plurality of sensors 20, and receives the sensor output SO from the sensors 20. In this manner, the plurality of sensors 20 are inspected. The display device 91 including the display unit 13 is configured to be a member provided separately from the above moving body 90. In this case, the unreceived-signal sensor 21 is displayed on the display unit 13 of the display device 91 to be visually recognizable by the viewer. Thus, the viewer viewing the display unit 13 can issue an instruction to take countermeasures to resolve the unreceived-signal state of the unreceived-signal sensor 21, to the moving body 90. Thus, measures to reduce the unreceived-signal sensor 21 can be swiftly taken during the inspection by the moving body 90, whereby the inspection time can be shortened.

The mobile terminal 30, the terminal 40, and the display device 91 described above may each be configured as a microcomputer including a CPU (processor), a memory such as a ROM and a RAM, a storage device such as an external storage device, an I/O interface, and a communication interface, which are not illustrated. The moving body 90 described above may have a microcomputer including a CPU (processor), a memory such as a ROM and a RAM, a storage device such as an external storage device, an I/O interface, and a communication interface, which are not illustrated installed therein. The CPU may operate (for example, perform a data operation or the like) in accordance with, for example, program instructions loaded into the main storage device of the memory to implement each of the above-described units of the mobile terminal 30, the terminal 40, the moving body 90, and the display device 91.

The present disclosure is not limited to the above-described embodiments, and includes embodiments obtained by modifying the above-described embodiments and embodiments obtained by appropriately combining these embodiments.

The contents of the embodiments described above can be understood as follows, for example.

1) A visual recognition system (10) according to at least one embodiment of the present disclosure is a visual recognition system (10) configured to display an unreceived-signal sensor (21) among a plurality of sensors (20) that are inspection targets, including:

a reception unit (11) configured to be capable of receiving a sensor output (SO) transmitted from each of the plurality of sensors (20), the sensor output (SO) including identification information on the sensor (20);

an unreceived-signal sensor identification unit (12) configured to identify the unreceived-signal sensor (21) the sensor output (SO) from which has not been received by the reception unit (11), among the plurality of sensors (20); and

a display unit (13) configured to display the unreceived-signal sensor (21) identified by the unreceived-signal sensor identification unit (12), to be visually recognizable by a viewer.

With the configuration of 1) described above, the unreceived-signal sensor identification unit (12) can identify, as the unreceived-signal sensor (21), the sensor (20) other than the received-signal sensor (22) the sensor output (SO) from which has been received by the reception unit (11) among the plurality of sensors (20) that are the inspection targets. With the unreceived-signal sensor (21) identified by the unreceived-signal sensor identification unit (12) displayed on the display unit (13) to be visually recognizable by the viewer, the viewer viewing the display unit (13) can recognize the unreceived-signal sensor (21). In this case, countermeasures for resolving the unreceived-signal state of the unreceived-signal sensor (21), such as patrolling by an inspector near the unreceived-signal sensor (21) in an attempt to retry the reception, can be swiftly taken, whereby the problem related to the unreceived-signal sensor (21) can be resolved in a shorter period of time and thus the inspection time can be shortened.

2) In some embodiments, the visual recognition system (10) described in 1) described above includes

a mobile terminal (30) including at least the reception unit (11) and the display unit (13).

With the configuration of 2) described above, the unreceived-signal sensor (21) is displayed, on the display unit (13) of the mobile terminal (30), to be visually recognizable by the viewer. Thus, the inspector (viewer) carrying the mobile terminal (30) can be prompted to take countermeasures for resolving the unreceived-signal state of the unreceived-signal sensor (21). Thus, the inspector can swiftly take measures to reduce the unreceived-signal sensor (21) during the inspection, whereby the inspection time can be shortened.

3) In some embodiments, in the visual recognition system (10) described in 2) described above,

the mobile terminal (30) further includes a map acquisition unit (51) configured to be capable of acquiring a map (52) of an inspection area including the unreceived-signal sensor (21), and

the display unit (13) is configured to be capable of displaying the unreceived-signal sensor (21) with a position of the unreceived-signal sensor (21) overlapping the map (52) acquired by the map acquisition unit (51).

With the configuration of 3) described above, the unreceived-signal sensor (21) is displayed while being positioned on the map (52) of the inspection area displayed on the display unit (13), so that the viewer (inspector) viewing the display unit (13) can easily and swiftly recognize the position of the unreceived-signal sensor (21). Countermeasures for resolving the unreceived-signal state of the unreceived-signal sensor (21) can be swiftly taken by the inspector who has recognized the position of the unreceived-signal sensor (21), whereby the problem related to the unreceived-signal sensor (21) can be resolved in a shorter period of time and thus the inspection time can be shortened.

4) In some embodiments, in the visual recognition system (10) described in 2) described above,

the mobile terminal (30) further includes an image capturing unit (55) configured to be capable of capturing an image, and

the display unit (13) is configured to be capable of displaying the unreceived-signal sensor (21) with a position of the unreceived-signal sensor (21) overlapping the image (56) captured by the image capturing unit (55).

With the configuration of 4) described above, the unreceived-signal sensor (21) is displayed while being positioned on the image (56) captured by the image capturing unit (55) and displayed on the display unit (13), so that the viewer (inspector) viewing the display unit (13) can easily and swiftly recognize the position of the unreceived-signal sensor (21), compared with the case of displaying on the map (52). Countermeasures for resolving the unreceived-signal state of the unreceived-signal sensor (21) can be swiftly taken by the inspector who has recognized the position of the unreceived-signal sensor (21), whereby the problem related to the unreceived-signal sensor (21) can be resolved in a shorter period of time and thus the inspection time can be shortened.

5) In some embodiments, in the visual recognition system (10) described in 3) or 4) described above,

the mobile terminal (30) further includes a route information acquisition unit (61) configured to be capable of acquiring route information (62) being information on a route (63) of an inspector, and

the display unit (13) is configured to be capable of displaying the route (63) of the inspector together with the position of the unreceived-signal sensor (21).

With the configuration of 5) described above, the route (63) of the inspector is displayed on the display unit (13) together with the position of the unreceived-signal sensor (21), so that the viewer (inspector) viewing the display unit (13) can easily and swiftly recognize the position of the unreceived-signal sensor (21). Furthermore, with the route (63) of the inspector displayed on the display unit (13), the viewer (inspector) viewing the display unit (13) can be swiftly guided to the next inspection point, whereby the inspection time can be shortened.

6) In some embodiments, in the visual recognition system (10) described in any one of 3) to 5) described above,

the mobile terminal (30) further includes an accompanying information acquisition unit (64) configured to be capable of acquiring at least one of sensor accompanying information (65) being information on each of the plurality of sensors (20) or device accompanying information (66) being information on devices (23) to which the plurality of sensors (20) are respectively attached, and

the display unit (13) is configured to be capable of displaying at least one of the sensor accompanying information (65) or the device accompanying information (66), together with the position of the unreceived-signal sensor (21).

With the configuration of 6) described above, the sensor accompanying information (65) and the device accompanying information (66) are displayed on the display unit (13) together with the position of the unreceived-signal sensor (21), so that the viewer (inspector) viewing the display unit (13) can easily and swiftly recognize the position of the unreceived-signal sensor (21) and the position of the device (23) to which the unreceived-signal sensor (21) is attached. In particular, the sensor accompanying information (65) and the device accompanying information (66) are effectively displayed for identifying the unreceived-signal sensor (21) among the plurality of sensors (20) in a location with a high sensor density in which the plurality of sensors (20) are arranged.

7) In some embodiments, in the visual recognition system (10) described in any one of 2) to 6) described above,

the display unit (13) is configured to be capable of displaying the unreceived-signal sensor (21) and a received-signal sensor (22) the sensor output (SO) from which has been received by the reception unit (11), in a common list (67), and to be capable of displaying the unreceived-signal sensor (21) in a mode different from a mode of the received-signal sensor (22) on the common list (67).

With the configuration of 7) described above, the display unit (13) displays the unreceived-signal sensor (21) and the received-signal sensor (22) on the common list (67), so that whether there is an unreceived-signal sensor (21) on the list (67) can be easily recognized. Thus, a failure to receive the sensor output (SO) from the plurality of sensors (20) displayed on the list (67) can be suppressed.

8) In some embodiments, in the visual recognition system (10) described in any one of 2) to 7) described above,

the mobile terminal (30) further includes a notification unit (68) configured to be capable of outputting a notification sound or voice for issuing a notification indicating that the unreceived-signal sensor identification unit (12) has identified the unreceived-signal sensor (21).

With the configuration of 8) described above, the notification unit (68) outputs the notification sound or voice, so that the inspector can recognize that there is an unreceived-signal sensor (21) without constantly viewing the display unit (13). Thus, a failure to receive the sensor output (SO) from the plurality of sensors (20) that are the inspection targets can be suppressed.

9) In some embodiments, in the visual recognition system (10) described in any one of 2) to 8) described above,

the mobile terminal (30) further includes a countermeasure acquisition unit (71) configured to acquire information (72) on a countermeasure to enable reception of the sensor output (SO) from the unreceived-signal sensor (21), and

the display unit (13) is configured to be capable of displaying the information (72) on the countermeasure, when the unreceived-signal sensor identification unit (12) identifies the unreceived-signal sensor (21).

With the configuration of 9) described above, when the unreceived-signal sensor identification unit (12) identifies the unreceived-signal sensor (21), the display unit (13) displays a guidance (the information 72 on the countermeasure), so that the viewer (inspector) viewing the display unit (13) can swiftly take the countermeasure for resolving the unreceived-signal state of the unreceived-signal sensor (21). Thus, the problem related to the unreceived-signal sensor (21) can be resolved in a shorter period of time and thus the inspection time can be shortened.

10) In some embodiments, in the visual recognition system (10) described in 9) described above,

the mobile terminal (30) further includes an input unit (73) configured to enable input of at least one of the countermeasure that has enabled the reception of the sensor output (SO) from the unreceived-signal sensor (21) by the reception unit (11) or a reason associated with the countermeasure.

With the configuration of 10) described above, the countermeasure that has enabled the reception of the sensor output (SO) from the unreceived-signal sensor (21) by the reception unit (11) and the reason associated with the countermeasure are stored and accumulated, so that a main reason that has resulted in the unreceived-signal sensor (21) and the effective countermeasure for the main reason can be recognized. With this configuration, a more appropriate guidance (information 72 on the countermeasure) can be displayed on the display unit (13) in response to the identification of the unreceived-signal sensor (21), whereby the problem related to the unreceived-signal sensor (21) can be resolved in a shorter period of time and thus the inspection time can be shortened.

11) In some embodiments, in the visual recognition system (10) described in any one of 2) to 10) described above,

the mobile terminal (30) further includes a reception difficulty information acquisition unit (81) configured to acquire reception difficulty information (82) indicating a level of difficulty of reception from each of the plurality of sensors (20), and

the display unit (13) is configured to display a sensor (29) with a high reception difficulty, among the plurality of sensors (20), to be visually recognizable by the viewer.

With the configuration of 11) described above, the following effect can be achieved. Specifically, the sensor (29) with a high reception difficulty has a low communication strength at its installed location, and thus is likely to be the unreceived-signal sensor (21). With the sensor that is likely to be the unreceived-signal sensor (21) displayed in advance on the display unit (13) of the mobile terminal (30) to be visually recognizable by the viewer, the viewer (inspector) can be prompted to patrol near the sensor (29) with the high reception difficulty. With the inspector patrolling near the sensor (29) with a high reception difficulty, a distance between the reception unit (11) and the sensor (29) with a high reception difficulty can be made short, whereby transition of the sensor (29) with a high reception difficulty to the unreceived-signal sensor (21) can be suppressed. Thus, the number of unreceived-signal sensors (21) can be reduced in the initial course of the inspection, whereby the inspection time can be reduced.

12) In some embodiments, the visual recognition system (10) described in 1) described above further includes:

a moving body (90) including the reception unit (11); and

a display device (91) configured to be a member provided separately from the moving body (90), the display device (91) including the display unit (13).

With the configuration of 12) described above, the moving body (90) including the reception unit (11) patrols in the inspection area provided with the plurality of sensors (20), and receives the sensor output (SO) from the sensors (20). In this manner, the plurality of sensors (20) are inspected. The display device (91) including the display unit (13) is configured to be a member provided separately from the above moving body (90). In this case, the unreceived-signal sensor (21) is displayed on the display unit (13) of the display device (91) to be visually recognizable by the viewer. Thus, the viewer viewing the display unit (13) can issue an instruction to take countermeasures to resolve the unreceived-signal state of the unreceived-signal sensor (21), to the moving body (90). Thus, the moving body (90) can swiftly take measures to reduce the unreceived-signal sensor (21) during the inspection, whereby the inspection time can be shortened.

13) A visual recognition method (100) according to at least one embodiment of the present disclosure is a visual recognition method (100) for displaying an unreceived-signal sensor (21) among a plurality of sensors (20) that are inspection targets, the visual recognition method including:

receiving (S101) a sensor output (SO) transmitted from each of the plurality of sensors (20), the sensor output (SO) including identification information on the sensor (20);

identifying (S102) the unreceived-signal sensor (21) the sensor output (SO) from which has not been received in the receiving (S101), among the plurality of sensors (20); and

displaying (S103) the unreceived-signal sensor (21) identified in the identifying (S102), to be visually recognizable by a viewer.

With the method of 13) described above, in the unreceived-signal sensor identification step (S102), the unreceived-signal sensor (21) can be identified as the sensor (20) other than the received-signal sensor (22) the sensor output (SO) from which has been received in the reception step (S101) among the plurality of sensors (20) that are the inspection targets. In the display step (S103), the unreceived-signal sensor (21) identified in the unreceived-signal sensor identification step (S102) is displayed to be visually recognizable by the viewer, so that the viewer viewing the display can recognize the unreceived-signal sensor (21). In this case, countermeasures for resolving the unreceived-signal state of the unreceived-signal sensor (21), such as patrolling by an inspector near the unreceived-signal sensor (21) in an attempt to retry the reception, can be swiftly taken, whereby the problem related to the unreceived-signal sensor (21) can be resolved in a shorter period of time and thus the inspection time can be shortened.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A visual recognition system configured to display an unreceived-signal sensor among a plurality of sensors that are inspection targets, the visual recognition system comprising:
a reception unit configured to be capable of receiving a sensor output transmitted from each of the plurality of sensors, the sensor output including identification information on the sensor;
an unreceived-signal sensor identification unit configured to identify, among the plurality of sensors, the unreceived-signal sensor, the sensor output from which has not been received by the reception unit; and
a display unit configured to display the unreceived-signal sensor identified by the unreceived-signal sensor identification unit, to be visually recognizable by a viewer.

2. The visual recognition system according to claim 1, further comprising a mobile terminal including at least the reception unit and the display unit.

3. The visual recognition system according to claim 2, wherein
the mobile terminal further includes a map acquisition unit configured to be capable of acquiring a map of an inspection area in which the unreceived-signal sensor is present, and
the display unit is configured to be capable of displaying the unreceived-signal sensor with a position of the unreceived-signal sensor overlapping the map acquired by the map acquisition unit.

4. The visual recognition system according to claim 2, wherein
the mobile terminal further includes an image capturing unit configured to be capable of capturing an image, and
the display unit is configured to be capable of displaying the unreceived-signal sensor with a position of the unreceived-signal sensor overlapping the image captured by the image capturing unit.

5. The visual recognition system according to claim 3, wherein
the mobile terminal further includes a route information acquisition unit configured to be capable of acquiring route information being information on a route of an inspector, and
the display unit is configured to be capable of displaying the route of the inspector together with the position of the unreceived-signal sensor.

6. The visual recognition system according to claim 3, wherein
the mobile terminal further includes an accompanying information acquisition unit configured to be capable of acquiring at least one of sensor accompanying information being information on each of the plurality of sensors or device accompanying information being information on devices to which the plurality of sensors are respectively attached, and
the display unit is configured to be capable of displaying at least one of the sensor accompanying information or the device accompanying information, together with the position of the unreceived-signal sensor.

7. The visual recognition system according to claim 2, wherein the display unit is configured to be capable of displaying the unreceived-signal sensor and a received-signal sensor, the sensor output from which has been received by the reception unit, in a common list, and to be capable of displaying the unreceived-signal sensor in a mode different from a mode of the received-signal sensor, in the common list.

8. The visual recognition system according to claim 2, wherein the mobile terminal further includes a notification unit configured to be capable of outputting a notification sound or voice for issuing a notification indicating that the unreceived-signal sensor identification unit has identified the unreceived-signal sensor.

9. The visual recognition system according to claim 2, wherein
the mobile terminal further includes a countermeasure acquisition unit configured to acquire information on a countermeasure to enable reception of the sensor output from the unreceived-signal sensor, and
the display unit is configured to be capable of displaying the information on the countermeasure, when the unreceived-signal sensor identification unit identifies the unreceived-signal sensor.

10. The visual recognition system according to claim 9, wherein the mobile terminal further includes an input unit configured to enable input of at least one of the countermeasure that has enabled the reception of the sensor output from the unreceived-signal sensor by the reception unit or a reason associated with the countermeasure.

11. The visual recognition system according to claim 2, wherein
the mobile terminal further includes a reception difficulty information acquisition unit configured to acquire reception difficulty information indicating a level of difficulty of reception from each of the plurality of sensors, and
the display unit is configured to display a sensor with a high reception difficulty, among the plurality of sensors, to be visually recognizable by the viewer.

12. The visual recognition system according to claim 1, further comprising:
a moving body including the reception unit; and
a display device configured to be a member provided separately from the moving body, the display device including the display unit.

13. A visual recognition method for displaying an unreceived-signal sensor among a plurality of sensors that are inspection targets, the visual recognition method comprising:
receiving a sensor output transmitted from each of the plurality of sensors, the sensor output including identification information on the sensor;
identifying, among the plurality of sensors, the unreceived-signal sensor, the sensor output from which has not been received in the receiving; and
displaying the unreceived-signal sensor identified in the identifying, to be visually recognizable by a viewer.
